(19) United States
(12) Patent Application Publication
(10) Pub. No.: US 2024/0094687 A1
(43) Pub. Date: Mar. 21, 2024

(54) DIGITAL TWIN-BASED SYSTEM AND METHOD FOR OPERATIONAL CONTROL OF A PHYSICAL SYSTEM

(71) Applicant: Dallas/Fort Worth International Airport Board, DFW Airport, TX (US)

(72) Inventor: Robert Horton, Lewisville, TX (US)

(21) Appl. No.: 18/467,519

(22) Filed: Sep. 14, 2023

Related U.S. Application Data
(60) Provisional application No. 63/375,828, filed on Sep. 15, 2022.
(60) Provisional application No. 63/376,988, filed on Sep. 23, 2022.

(51) Int. Cl. G05B 13/04

(52) U.S. Cl. CPC G05B 13/048

(57) ABSTRACT

A method for digital twin-based operational control of a physical system is implemented by at least one processor. The method includes receiving passenger throughput data corresponding to a building that is climate controlled by at least one chiller. The method includes estimating a cooling load value as a function of time to maintain a specified indoor air temperature of the building, based on the passenger throughput data. The method includes controlling an ON/OFF state of the at least one chiller based on the cooling load value.

### CROSS-REFERENCE TO RELATED APPLICATION(S) AND CLAIM OF PRIORITY

This application claims the benefit of the filing date of U.S. Provisional Patent Application No. 63/375,828 filed on Sep. 15, 2022, and U.S. Provisional Patent Application No. 63/376,988 filed on Sep. 23, 2022. The above-identified provisional patent applications are hereby incorporated by reference in their entireties. This application contains some subject matter in common with, but is otherwise unrelated to, concurrently filed United States Patent Application entitled “Digital Twin-based System and Method for Reducing Peak Power and Energy Consumption in a Physical System,” application Ser. No. ______ (attorney docket DALL16-00049), which is hereby incorporated herein by reference in its entirety.

### TECHNICAL FIELD

This disclosure generally relates to management and control of a system. More specifically, this disclosure relates to digital twin-based operational control of a physical system.

### BACKGROUND

Modern society increasingly relies upon complex and interconnected infrastructure to function in a manner that enables sustained growth. When this infrastructure performs well and meets service delivery requirements, societal activity can continue in a manner consistent with policy incentives, goals, and needs. Conversely, when such infrastructure struggles to meet service requirements because of external stressors and disruptions or deterioration, the implications to societal wellbeing can be vast. System-level disruptions involving this infrastructure can cause a variety negative consequences, including: economic losses, damaged human health, reduced societal trust, reduced societal cohesion, or hazardous environmental implications. Of great concern are situations in which infrastructure disruption contributes to cascading systemic failure and situations in which disruptions to infrastructure percolate through society causing devastating and potentially irreversible outcomes. For example, in February 2021, Winter Storm Uri brought frigid temperatures (particularly, eight days of below freezing temperatures) to a widespread geographical area across the North American continent, including parts of Canada, the United States of America, and northern parts of Mexico. During Winter Storm Uri, cascading failures of interdependent infrastructure systems within the electrical grid within Texas deprived millions of people of heat and electricity for an extended period.

Historically, as a solution to safeguard infrastructure from system-level disruptions, various stakeholders utilize a risk assessment approach that is to: characterize threats, evaluate vulnerabilities, and identify direct and indirect (or unintended) consequences associated with disruption. Unfortunately, for modern infrastructure, many threats (for example, human pathogens or regional extreme weather events) are difficult to anticipate.

### SUMMARY

This disclosure provides digital twin-based operational control of a physical system.

In a first embodiment, a method for digital twin-based operational control of a physical system is implemented by at least one processor. The method includes receiving passenger throughput data corresponding to a building that is climate controlled by at least one chiller. The method includes estimating a cooling load value as a function of time to maintain a specified indoor air temperature of the building, based on the passenger throughput data. The method includes controlling an ON/OFF state of the at least one chiller based on the cooling load value.

In a second embodiment, an electronic device for digital twin-based operational control of a physical system digital twin-based system and method for operational control of a physical system is provided. The electronic device includes a processor configured to receive passenger throughput data corresponding to a building that is climate controlled by at least one chiller. The processor is configured to estimate a cooling load value as a function of time to maintain a specified indoor air temperature of the building, based on the passenger throughput data. The processor is configured to control an ON/OFF state of the at least one chiller based on the cooling load value.

In a third embodiment, a non-transitory computer readable medium comprising program code for supporting digital twin-based operational control of a physical system is provided. The computer program includes computer readable program code that, when executed by a processor of an electronic device, causes the electronic device to receive passenger throughput data corresponding to a building that is climate controlled by at least one chiller. The computer readable program code causes the electronic device to estimate a cooling load value as a function of time to maintain a specified indoor air temperature of the building, based on the passenger throughput data. The computer readable program code causes the electronic device to control an ON/OFF state of the at least one chiller based on the cooling load value.

Other technical features may be readily apparent to one skilled in the art from the following FIGS., descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example electronic device supporting digital twin-based operational control of a physical system according to this disclosure;

FIG. 2 illustrates an example Social-Ecological-Infrastructural-System (SEIS) according to this disclosure;

FIG. 3 illustrates an example Resilience Matrix (RM) according to this disclosure;

FIG. 4 illustrates an example method for understanding how the interacting airport systems perform across the four phases of a disruptive event for various scenarios according to this disclosure;

FIG. 5A illustrates a central plant optimization system, according to embodiments of this disclosure;

FIG. 5B illustrates a user interface showing timelines of values representing the operations of the MPC process, according to embodiments of this disclosure;

FIG. 6 illustrates an Informative Analytics tool according to embodiments of this disclosure; and

FIG. 7 illustrates a method for digital twin-based operational control of a physical system, in accordance with an embodiment of this disclosure.

### DETAILED DESCRIPTION

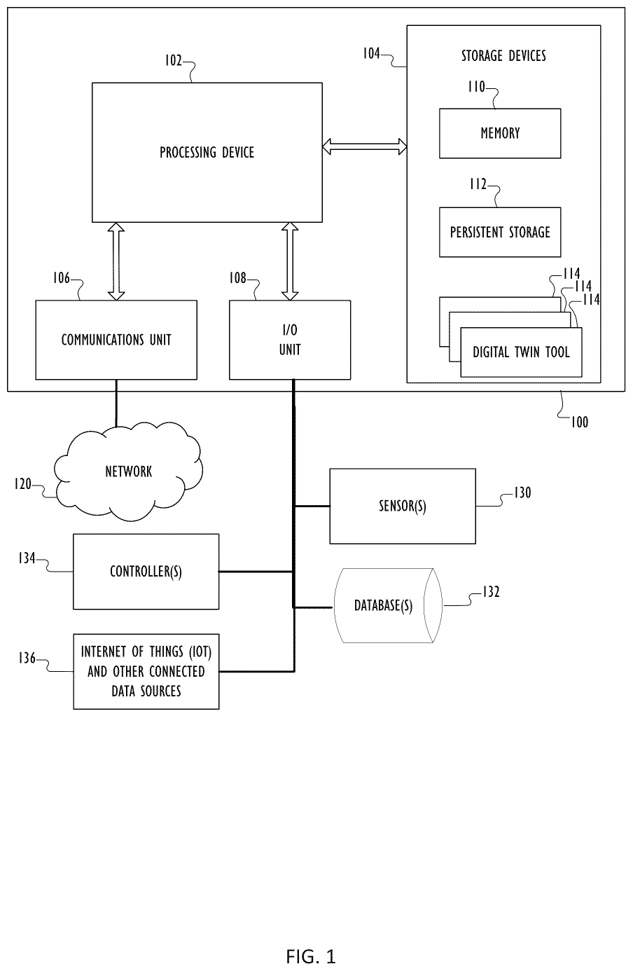

FIGS. 1 through 7, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As described above, a risk assessment approach is a historical solution that is difficult for modern infrastructure. The ‘state-of-the-art’ standard for risk assessment has been of crucial benefit when a ‘risk object’ (also referred to as a ‘threat’) is well characterized and predictable in its behavior, as well as when an ‘object at risk’ (also referred to as ‘affected system’) is thoroughly mapped and understood based upon its vulnerabilities and operational needs. However, when the risks or risk objects are poorly characterized or novel, or when the affected system is composed of multiple interlocking nested dependencies, the risk assessment will often overstate or understate the response needed to address the associated risk object. Unfortunately, in the case of modern infrastructure, many threats (for example, human pathogens, regional extreme weather events) are difficult to anticipate or relatively novel in terms of scale and complexity. At the same time, modern infrastructural dependencies have grown too complex to evaluate with a siloed approach, such as the risk assessment approach. An example complexity that is too complex for a siloed risk assessment approach is weather events that cause flight delays and create difficulties for people to access the airport, for example, via ground transportation.

According to this disclosure, airports and airlines are prime examples of this challenge. As a complex network, air travel requires the symbiotic and sustainable operations of various systems and stakeholders to achieve the desired outcome: the airlines (including physical aircraft and crews, among others), the airport (including components of infrastructure, communications, energy, and labor, among others), the security and risk compliance (including multiple state and federal agencies and regulations), and vendors (including food and beverage, luxury goods, and many others). Each component has a vast and interconnected web that moves based on predetermined flight plans and strategic scheduling based on passenger and cargo traffic demand.

These systems can be heavily impacted due to stressors that affect those either independently or in conjunction (e.g., climate change and infrastructure fatigue). The COVID-19 pandemic is an example of a global stressor for airport and airline systems. With reduced passenger demand, changing workforce numbers, and simultaneously shifting priorities to aid in the transport of critical medical supplies, airports and airlines had to recover from and adapt to multiple sweeping changes to their operations—often with little notice and an incomplete understanding of how society would respond to the pandemic long-term. For the airports, the COVID pandemic demonstrated the critical need for a holistic, systems-driven evaluation capability that includes but moves beyond traditional risk assessment. Critically, complements include resilience and sustainability—ensuring airports can recover from and adapt to future uncertain disruptions, while continuing to meet societal expectations for services and environmental impact and remain sustainably financially profitable.

Unfortunately, few resilience-driven tools exist to guide airports and airlines toward this new way of dealing with systemic risk. While practitioners have fostered tools and capabilities to evaluate infrastructural resilience, airports are unique in their requirements to abide by a weighty list of rules for safety and security, let alone maintain an enjoyable passenger experience, minimize harmful environmental impact (e.g., emissions, noise, etc.), and remain financially sustainable (cost-per-passenger).

Given increased attention to airport operations via the Bipartisan Infrastructure Law (B.I.L.), U.S. airports have a rare opportunity to consider how to adapt their operations and infrastructure to incorporate resilience as a philosophy and a practice. To meet this need, this disclosure proposes a three-part approach to (a) craft and apply an understanding of a principled resilience approach to airports, (b) take this development and use it to foster a quantifiable multi-criteria decision framework, and (c) use those quantitative frameworks and framings of airport systems to evaluate real-time and scenario-driven airport activities and disruptions.

While this approach cannot predict or prevent all disasters, placing airports on better footing to absorb, recover from, and adapt to a wide universe of threats and sustainably maintain operations will yield substantial benefits to airport stakeholders as well as the broader societies that they service. And, as air travel demand recovers from the COVID disruption (at a projected 5% annual passenger growth rate according to F.A.A.'s Aerospace forecast from 2021 to 2041), and the range of stressors upon airports continues to diversify and become less predictable, it is imperative that airports systematically invest in their resilience capabilities against disruption. The first step toward accomplishing this is to develop, test, and transfer a quantifiable methodology that can allow airport operators to visualize systemic risk, evaluate airport operations and infrastructure performance under a range of historical and prospective scenarios, and comparatively evaluate improvements to reduce disruptions and maintain cost requirements.

Historical research in the various sciences (e.g., social, ecological, civil) has advanced our knowledge of each field's crucial issues. For example, in the ecological research field, the risks and stressors and the ability of the systems to adapt to changing conditions are well understood. The most recent the Intergovernmental Panel on Climate Change (IPCC) report clearly outlined the linkage between anthropogenic emission sources on the earth system model and the urgency required to prevent a total collapse of the Earth System. Over the past five years, there has been an increasing call for interdisciplinary research to better understand the interactions between systems, enabling scientists, policymakers, and industry actors to coordinate their actions and achieve the common future prescribed in the Brundtland Report. Embodiments of this disclosure apply to a physical system, which can be a small-scale ecosystem, such as an airport, or can be a larger-scale system, such as one or more institution campuses, cities, states, and countries. For ease of description, embodiments of this disclosure are described as applied to an airport.

This disclosure reviews existing risk-based approaches and subsequently identify opportunities to define, analyze, and implement systems-driven resilience for airports: the capacity for a system to recover and adapt after disruption. There is an urgent need to rethink how airports govern risks. These include direct threats, indirect threats, and downstream implications. Airports are more than a place for flights to take off and land—they have a sizeable and growing list of responsibilities that must be met for safety and societal purposes, including a range of safety requirements as well as aspirational sustainable development goals.

Conventional approaches (e.g., risk-based assessment methodologies) were appropriate to manage threats of prior time periods—but are not well-suited on a standalone basis to deal with the systemic challenges facing many airports. Many emerging threats challenge airport sustainability in new and unpredictable ways that are difficult to ameliorate. Through a resilience-based philosophy, accompanying tools would be able to quantify system behavior before, during, and after disruptions occur, as well as evaluate the costs and benefits associated with various recovery strategies.

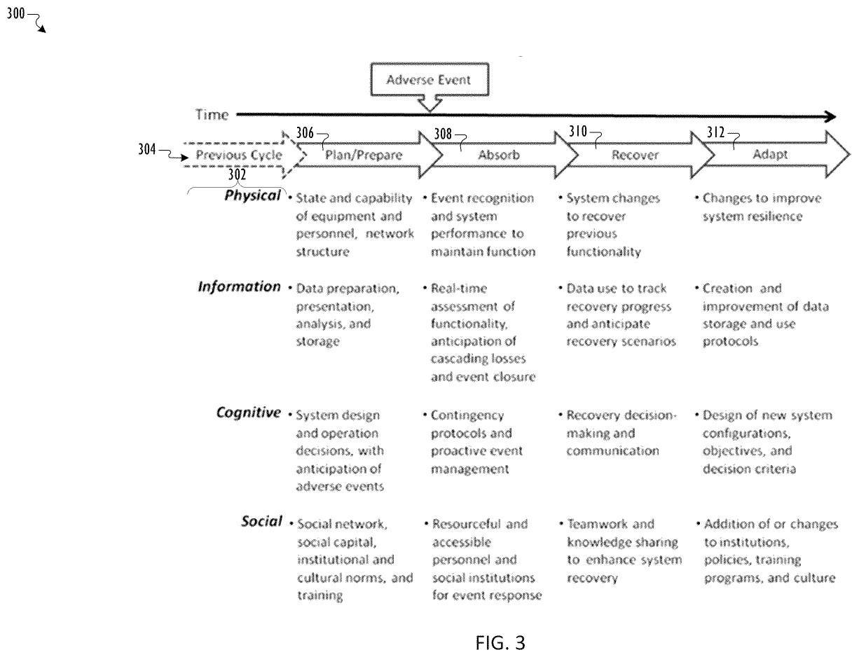

The systems and methods according to this disclosure will not only better safeguard airports against systemic and extreme disruption, but also provide a more financially secure base and infrastructural sustainability to guarantee their future against a broad universe of unknowable threats. This objective is achieved through the following three aspects of the systems of this disclosure. As one aspect, the systems of this disclosure applies a resilience matrix (for example, RM 300 of FIG. 3) to analyze a physical system. The structure of resilience matrix includes a physical domain for modeling state and capability of physical system, such as a large hub international airport. The airport includes complex socio-ecological systems with many interdependent functions, drivers, and requirements. As a second aspect, the systems of this disclosure measure airport operations and performance in a spatial context and time context. Particularly, the structure of resilience matrix includes an information domain for receiving state data from actuators and measurement data from sensors, which are timestamped and marked with spatial contextual data (e.g., physical location and/or position). The spatial and time components in the structure of the data received into the systems of this disclosure enable multi-criteria decision support tools to analyze airports based upon components of spatial and time requirements. Also, the structure of the data received into the systems of this disclosure enable threat-agnostic systems assessment of airport operations and performance against a range of potential risk objects. As a third aspect, the systems of this disclosure predict a timeline of behavior (e.g., predicted state data and predicted measurement data as a predicted output) of the physical system in response to input that includes a grouping of resources and a grouping of stressors, by using a model trained to make predictions based on training data (e.g., historical time-series data). In this disclosure, the model trained within the digital twin tool (DT) 114 of FIG. 1 can be simply referred to as the DT. Particularly, a selection of scenarios that include chronic and acute stressors are selected from historical data (including spatial and time components) to train the model to learn what is the behavior of the physical system in response to that selection's grouping of resources and grouping of stressors. That is, the training data (and real-time data being collected) is divided into resources, stressors, and output. The training data is marked with stages of resilience and domains of resilience according to the resilience matrix. In an operating context, the systems of this disclosure can use the trained model to predict a timeline of behavior of the physical system in response to input that includes real-time resources and stressors. In an offline context to prepare a plan for a future adverse scenario, the trained model can be used predict behavior of the physical system in response to input that includes hypothetical resources and stressors. Accordingly, the DT tool of this disclosure includes resilience-based decision support tools that are applied to real-time, assets-based assessment. The DT tool of this disclosure enables repeated iterations of stress testing of airport functionality amidst shifting conditions and usage of assets.

Embodiments of this disclosure provide a new resilience-based decision support approach for airports. Methodologically, any such toolkit must be able to assess various components of airport infrastructure, operations, and policy—ranging from core infrastructure to enable takeoffs and landings (core infrastructure and personnel), to financial sustainability, to environmental and societal implications. Consequently, selected methods for this task (described below) include multi-criteria decision analysis and digital twin assessment (interdependent network analysis and asset management). These decision methods allow entities to incorporate uncertain or changing information into decision structures to stress-test alternatives under diverse management and global-driver scenarios. In addition, these decision tools that align objectives and program governance have direct and synergistic benefits on profitability, energy efficiency, ecosystem services, and public outreach.

Cities and airports have become microcosms of large-scale societal systems with nuanced behaviors based on their respective regions' temporal and spatial dynamics. With the U.N. projecting that almost 70% of the global population will reside in urban areas by 2050, the competition for natural and physical resources will challenge and push the connected ecological systems to their limits. One unique feature of airports is their governance, which simplifies modeling while remaining flexible to become scaled and applied to an urban setting. In addition, in the United States, airports have become a critical transportation infrastructure to influence the urban form and structure of a city's growth. In contrast, cities influence airports' scale and operations. The infrastructure planning policies and actions by airports and airlines create congestion impacts on surface transportation infrastructure surrounding airports, affecting the airlines' on-time performance. With the rise in demand for air travel, there will be increased local mobility shifts within the cities, which exposes airports to rapid changes in new transportation technologies and the associated infrastructure investments, policies, and revenues. Airports' infrastructure provides access to aircraft for landing and taking off while unlocking the potential for community growth. Using ecosystem theory to understand the complex interactions and system dynamics is a valuable outcome of coupling human and natural systems to pursue sustainable growth.

Airports are often referred to as cities nested within larger cities, and this comparison is relevant when studying the causal linkages between urbanization and environmental degradation. Building on the urban ecosystem concept, a theory is that sustainable environmental governance required “ . . . a better understanding of the causes and consequences of the complex patterns of interdependencies connecting people and ecosystems within and across scales.” Applying this theory to airports becomes imperative for identifying actions to counteract the ecological damage resulting from the economic drive to support urban growth.

The complexity of an airport ecosystem presents a unique challenge to attaining long-term sustainable growth objectives. To illustrate the airport's complexity, this disclosure dissects the airport's components according to economic, administrative (or management systems), and functional processes tied to their physical, cognitive (or decision structure), ecological, and social domains. Economically, airports are expected to maintain competitive operating & maintenance costs to ensure the cost to airlines improves competition for passenger service. From a functional perspective, the city infrastructure enables short-range mobility (i.e., cars, busses, bikes, and pedestrians) to meet residents, workers, and visitors' needs. On the other hand, airports efficiently connect people and goods over considerable distances. To fulfill their mobility goal, airports must maintain infrastructure for aircraft to land, take off, and support operations. From an administrative perspective, most U.S. airports are government-owned but effectively privately operated and governed by Federal Aviation Administration (F.A.A.) regulations. The F.A.A. also requires that airports become certified to ensure the national airport system's safety, efficiency, and environmentally responsible operations.

Four primary components generally characterize airport systems and boundaries: the airside, terminals, landside, and the surrounding communities. Airside operations include airspace and airfield operations and are governed by F.A.A. Part 139. Airports are urban microcosms that stimulate land development in and within their communities. Airport growth directly corresponds to community growth, as evidenced by increasing originating and connecting passengers and increased dwell time in the terminals. Like cities, airports offer services and amenities, such as retail, hotels, infrastructure, and entertainment, and serve as economic engines for businesses needing convenience for freight and passenger logistical and operational services. They serve as a primary connection of people, goods, and services; similar to cities, economic powerhouses facilitate new job opportunities and improve revenue sources.

Airside operations involve arriving and departing aircrafts. In the U.S., many airports experience similar challenges, such as growing demand for air travel (U.S. Bureau of Transportation Statistics), aircraft sizes, and the threat of disruptive technologies to the airport business model. Some relevant technological threats include the Transportation Network Companies (T.N.C.s) like Uber and Lyft, autonomous vehicles, and Unmanned Aerial Systems (U.A.S.s). Airports also face the same federal rules and regulations on funding, safety, security, and other issues. Nevertheless, most airports have managed to sustain sufficient investment in runways, terminals, and other services while maintaining strong credit ratings that airports use to receive preferred interest rates through sales of municipal bonds.

Efficiency drivers required urgent infrastructure investments following the deregulation of the airline industry and the resultant competition between private airline operators. Airport operators worldwide face increasing pressures from various political, socio-economic, technological, legal, and ecological factors. While an airport's primary function is to connect people and goods globally, the operational characteristics and risks draw scrutiny from regulators, airlines, investors, and criticism from passengers and the local communities they support. With the world's population projected to approach 10 billion by 2050, the United States (U.S.) is one of nine countries expected to absorb more than fifty percent of the projected increase, and urban areas will absorb almost all the growth. The United Nations also projects the U.S. population to grow by 78 million and surpass 400 million before 2060, with the number of people over 65 expected to double over the same period. Infrastructure investments remain a key priority to keep pace with urbanization trends, and the increased need for efficient and reliable operations of airports is central to that.

The complexity of decision-making for environmental projects is subjected to tradeoffs based on sociopolitical, environmental, ecological, and economic factors from stakeholders with varying priorities and objectives. This perspective is evident when considering the historical influences, policies, and actions that influenced many airports such as Dallas-Fort Worth (DFW) Airport's current sustainability and environmental compliance programs.

Embodiments of this disclosure enable objectives to be accomplished, such as to determine the vital and complex social-ecological and infrastructural system (SEIS) components, networks, and flows critical to measuring and evaluating the resilience and operational capacity of a physical system, such as an airport. In addition, embodiments of this disclosure can identify the performance and decision criteria required to adequately describe and manage resilient operational capacity and test various combinations of long-term ecological and social trends and short-term disruptions most likely to impact the operational capacity and resilience of the airport network. As a solution to these objectives, this disclosure provides a DT model of a physical system (e.g., an airport's complex system) to serve as a framework for rethinking our traditional approaches to topics like sustainable development and resilience. The DT model incorporates social, ecological, and infrastructure dimensions to measure and manage operational capacity and resilience. Further, to answer these objectives, this disclosure provides an annotated list of financial, regulatory, risk, and operational criteria that reflect the interacting decision management frameworks in use at an airport. Additionally, to answer these objectives, the DT tool of disclosure identifies the systems, critical functions, and metrics used to predict the physical system's behaviors and feedback/response mechanisms. As well, to answer these objectives, this disclosure utilizes a combination of scenario analysis, Resilience Matrix analysis, and multi-criteria decision analytics to evaluate the airport's system-level responses to historical, current, and future disruptions and visualize complex management tradeoffs under uncertainty. For example, an airport offers a unique opportunity to study urban systems and has a wealth of easily accessible data systems for modeling.

A current limitation for airport governance against systemic risks is the lack of a toolkit that provides the quantifiable means to evaluate airport resilience and brittleness. For resilience to succeed as a cultural and philosophical contribution to airport operations, it must be defined and applied in a manner that airport managers can measure. Embodiments of this disclosure accomplish this goal by applying resilience methods to decision science and evaluating airport performance against disruption through time (stages of resilience) and space (domains of resilience).

Decision sciences have long been utilized to evaluate infrastructural and ecological system performance against a range of uncertain stressors. Likewise, using definitions of resilience proposed by the U.S. National Academy of Sciences as the ability of a system to prepare for and absorb, recover from, and adapt to adverse events, demonstrate how the decision sciences can be used as a platform for resilience assessment of critical infrastructure by evaluating infrastructure system performance across the physical, cognitive, informational, social, and other domains. However, a considerable opportunity remains to adapt this approach, namely the ‘Resilience Matrix’ (for example, RM 300 of FIG. 3) and apply it to the unique context of airport infrastructure. In turn, decision science approaches can facilitate airport resilience assessment by evaluating airport operations against their legal/safety requirements, financial constraints, and societal expectations.

Within aviation infrastructure management, Airport Collaborative Decision-Making (A-CDM) has been posited as a useful and transformative framework to integrate multiple regulatory agencies, aviation enterprises, and airport operations as interdependent systems. A-CDM is a platform that can facilitate traditional risk analysis (threat, vulnerability, and consequence) while simultaneously including complementary assessment of airport resilience before, during, and after disruption (stages of resilience) and across various airport sub-systems and dependencies (domains of resilience).

Alone, risk-based approaches are deficient at evaluating the interdependency of airport systems, and their usefulness tends to be constrained to well-defined contexts and risks. While risk assessment still has value for airport risk management (the ability of a system component to withstand or absorb loss), adding in a resilience-based complement amplifies our understanding of how airport systems recover from a range of disruptions (known and unknown). And, most importantly, how insufficient recovery can percolate into systemic and cascading losses in safety, money, and societal values. The DT tool 114 (in FIG. 1) of this disclosure is conducts tradeoffs between risk and resilience for airports, which would subsequently guide airport managers in allocating scarce resources to improving airports' ability at withstanding or recovering from disruption.

Embodiments of this disclosure explore the scale and complexity of airport decision-making systems, including an evaluation of the tradeoffs and consequences. The embodiments of this disclosure include the following three aspects. One aspect includes to provide and evaluate resilience-based decision support tools that analyze airports based upon components of space and time. Such analysis enables threat-agnostic systems assessment of airport operations and performance against a range of potential risk objects. Another aspect includes to design and adapt the Resilience Matrix to the unique context of the physical system (e.g., airport) to evaluate the impact of decision-making and resulting tradeoffs across multiple domains (e.g., physical, cognitive, informational, social, ecological). For example, to help a policymaker make a selection from a list of state alternatives (i.e., alternative ways to change the state of the physical system in order to address an identified problem), the DT tool of this disclosure a receives a selection of stakeholder criteria to evaluate, predicts a value of each stakeholder criterion for informing the user of consequences that may result from each listed state alternative. The DT tool, by use multiple-criteria decision analysis (MCDA), determines a rank acceptability index for each listed state alternative, wherein the index represents an extent to which that state alternative satisfies the selected stakeholder criteria. The DT tool provides a resilience-based, multi-criteria decision support tool that analyzes a physical system (e.g., an airport) based on spatial and time requirements components. A comparison of these rank acceptability indices represents tradeoffs compared to concurrent satisfaction of all selected stakeholder criteria. Thirdly, another aspect includes to complete a comparative analysis of current decision-making frameworks in a complex airport ecosystem and test the applicability of a new multi-criteria decision-making method that reflects risk-based versus resilience-based ideologies' interacting and dynamic nature. For example, the DT tool of this disclosure can predict a first behavior of the physical system according to a risk-based selection from the list of state alternatives, then predict a second behavior of the physical system according to a resilience-based selection from the list of state alternatives, and display comparisons of the first and second behaviors predicted. By comparing predicted results derived from different hypotheticals, the DT tool quantifies consequences (i.e., the extent to which the selected stakeholder criteria are satisfied) of the list state alternatives so that policymakers can know the consequence the selected stakeholder criteria. These tools provide modern resources to aid airport managers in decision-making for resilience.

In 2019, the U.S. Department of Homeland Security Cybersecurity and Infrastructure Agency (CISA) published “A Guide to Critical Infrastructure Security and Resilience.” In this document, CISA defined critical infrastructure and designated four lifeline functions (i.e., transportation, water, energy, and communications). In addition, regarding the lifeline functions, CISA stated that “their reliable operations are so critical that a disruption or loss of one of these functions will directly affect the security and resilience of critical infrastructure within and across numerous sectors.” Whether the recent COVID-19 pandemic, the growing wave of billion-dollar disasters across the U.S., or the attractiveness of civil infrastructure for acts of terrorism, a new systematic and rigorous approach should be developed to preserve the operation of critical infrastructure regionally, nationally, and globally.

A critical issue in resilient airport operations is that integrated sensor and data analysis systems (for example, including sensors 130) bring detailed complex information streams into real-time infrastructure decision environments. A requirement includes evaluating airport operations, personnel, customers, and asset management with maximum granularity and under a range of scenarios (historical, prospective, seasonal/normal operations). Using digital twins for system-level analysis fosters the ability to evaluate airports as a series of interconnected networks. A digital twin is an accurate representation of an asset, which offers a solid, mutual, and continuous connection between the physical entity (airport) and its corresponding virtual copy. Through the digital twin 114 (FIG. 1), embodiments of this disclosure can explore the ‘what-ifs’ for different scenarios to understand how different types of disruptions affect airport performance and whether airport sub-systems recover lost functionality. Critically, this would allow us to conduct sensitivity analyses and more effectively plan for system improvements or system adaptations if and when such disruption occurs.

Applying resilience-based decision support tools to real-time, assets-based assessment enables the airport to optimize its investments in modernizing aging infrastructure as well as adapt to climate risks. For example, the DT tools of this disclosure enable repeated stress testing of airport functionality amidst shifting conditions and usage of assets. Embodiments of this disclosure provide one or more digital twins 114 (FIG. 1) to become the ‘Gold Standard’ in the experimentation and deployment of resilience support tools while enhancing critical infrastructure (physical and cyber). Embodiments of this disclosure: provide a design of a strategy/framework using a digital twins to address airport resilience analytics; and identify common characteristics and uses of Digital Twins in and out of aviation and the capabilities the offer.

The time for actions on reversing the course of anthropogenic emission sources is overdue. Since 2020, the devasting impacts of the COVID-19 pandemic highlight the need for updating the approach to resilience in science and practice. The embodiments of this disclosure leverage practical applications of scientific theories to an airport complex system to aid in advancing human understanding of how to study and improve critical infrastructural systems, which humans rely upon to deliver consistent and reliable performance. A central plant is one example of an airport's infrastructural system, and the central plant is designed to operate in a manual mode and to adjust an indoor air temperature inside a building based on an ON/OFF state of a set of chillers. In the manual mode, a cooling demand is fixed and predetermined based on an assumed environment (for example, an outdoor temperature of 95° F. all day at five terminal buildings), and the cooling demand is correlated to activating a number of chillers to operate at full cooling capacity. When COVID-19 significantly reduced the number of heat sources and people inside each building at the airport, the predetermined cooling demand was fixed and not adaptable to building occupancy. To solve this problem, an embodiment of this disclose provides an automated-control interface (AIC) that enables the central plant to operate in an automated-control mode. An embodiment of this disclosure provides an electronic device that executes a method for adjusting the cooling demand based on passenger throughput data, and using the adjusted cooling demand to control the central plant to put N chillers in the ON state for a specified period of time, and to put a remainder of the chillers in the OFF state during that period.

International airports are heavily regulated because of the potential for catastrophic failure. In addition, the COVID-19 pandemic has highlighted the vital role of airports as part of nationally-recognized critical infrastructure and within their respective communities in moving people and freight across the globe safely, efficiently, and timely. However, to meet the needs of growing communities, airports must bolster efforts around resilient decision-making on operational and infrastructural investments. Embodiments of this disclosure provide novel systems and methods to measure and monitor resilience in airports. In addition, this disclosure provides a unique perspective on operational metrics that represent critical functions, other operational criteria, and new decision-support tools to compensate for the direct and indirect consequences of significant tradeoffs, especially in the ecological domain.

Embodiments of this disclosure demonstrate the potential for Digital Twin tools 114 (FIG. 1) to conduct more robust stress testing and enhance the Resilience-by-Design strategies for critical infrastructure. Some embodiments of this disclosure include a system in which an electronic device controls physical components of a physical system to maintain a specified indoor air temperature of a building, based on passenger throughput data.

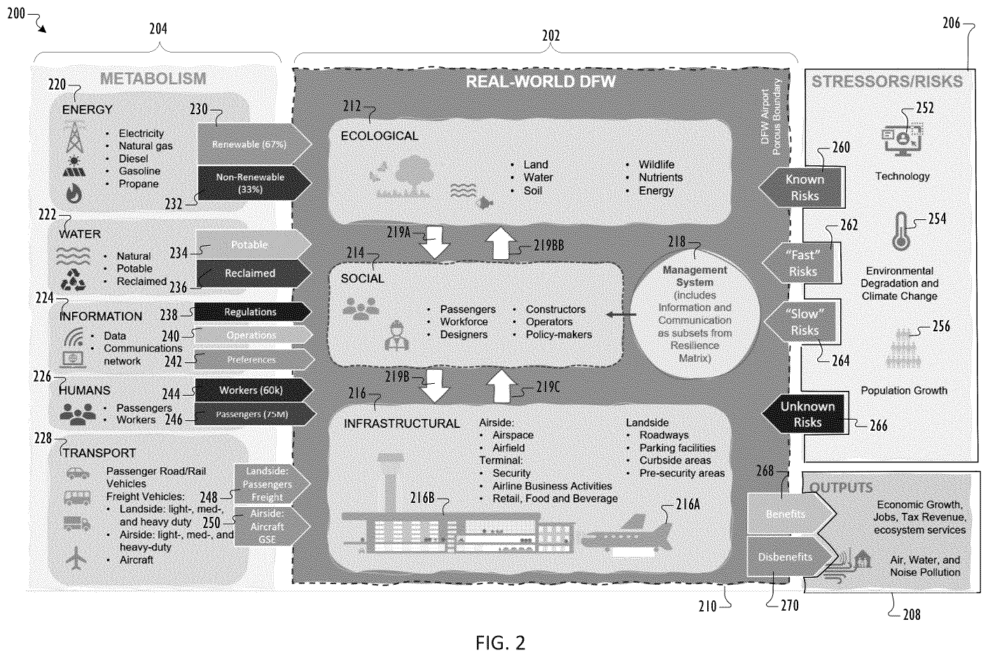

FIG. 1 illustrates an example electronic device 100 supporting digital twin-based operational control of a physical system according to this disclosure. The embodiment of the electronic device 100 shown in FIG. 1 is for illustration only. Other embodiments could be used without departing from the scope of the present disclosure. The electronic device 100 of FIG. 1 may, for example, be used in the Social-Ecological-Infrastructural-System (SEIS) 200 of FIG. 2 to interact with and control operation of the Management system 218, Information components 224, and/or system of technology 252.

As shown in FIG. 1, the electronic device 100 includes at least one processing device 102, at least one storage device 104, at least one communications unit 106, and at least one input/output (I/O) unit 108. The processing device 102 may execute instructions that can be loaded into a memory 110. The processing device 102 includes any suitable number(s) and type(s) of processors or other processing devices in any suitable arrangement. Example types of processing devices 102 include one or more microprocessors, microcontrollers, digital signal processors (DSPs), application specific integrated circuits (ASICs), field programmable gate arrays (FPGAs), or discrete circuitry. In some embodiments, the processing device 102 is a programmable logic controller (PLC) having user-selectable parameters.

The memory 110 and a persistent storage 112 are examples of storage devices 104, which represent any structure(s) capable of storing and facilitating retrieval of information (such as data, program code, and/or other suitable information on a temporary or permanent basis). The memory 110 may represent a random access memory or any other suitable volatile or non-volatile storage device(s). The persistent storage 112 may contain one or more components or devices supporting longer-term storage of data, such as a read only memory, hard drive, Flash memory, or optical disc. The persistent storage 112 is one example of a non-transitory computer readable medium. The storage devices 104 store at least one digital twin (DT) tool 114 of a physical system, and details about the DT tool 114 (simply referred to as “digital twin”) are described throughout this disclosure. In certain embodiments, the at least one DT tool 114 includes multiple DT tools 114, each of a different physical system. In certain embodiments, the DT tool 114 is a software platform executed on a group of servers.

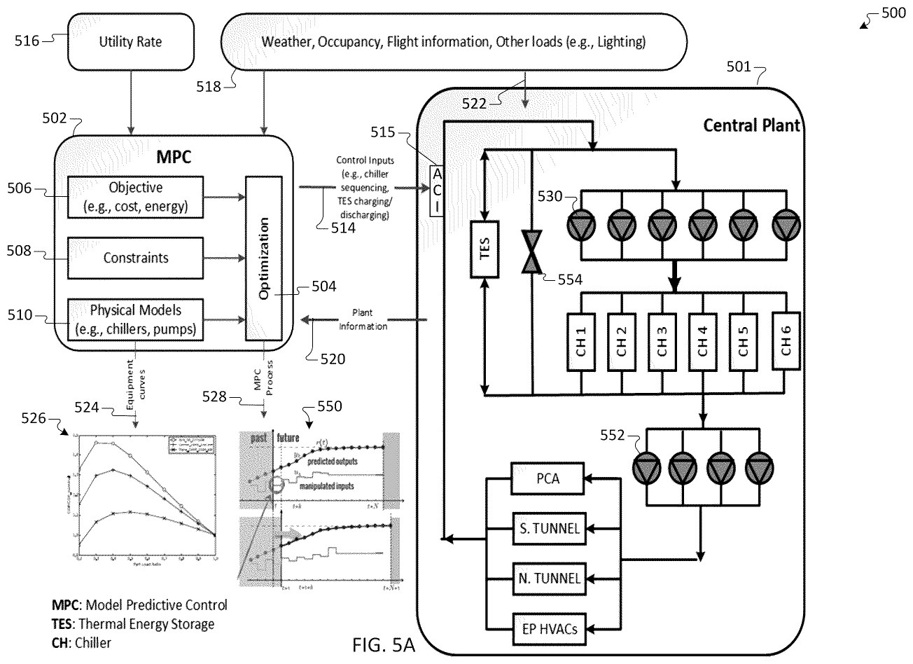

The DT tool 114 includes one or more physical models, such as the physical models 510 of FIG. 5, and a digital three-dimensional (3D) model of components in the physical system, which can include a computer-aided drawing (CAD). The DT tool 114 includes one or more predictive models, such as the model predictive control 502 of FIG. 5. To predict behaviors of the physical system, the DT tool 114 includes rules and relationships for interoperability of components within the physical system. For example, a valve allows fluid to flow through when an open/closed state of the valve is open, but not when closed. In some embodiments, the DT tool 114 includes an ability to automatically respond to demand response signals from an electric grid, thereby adapting the physical system to have demand response capabilities and enabling grid-interactive efficient buildings (GEB).

The communications unit 106 supports communications with other systems or devices. For example, the communications unit 106 may support communications with external systems that provide information to the electronic device 100 for use in digital twin-based operational control of a physical system. The communications unit 106 may support communications through any suitable physical or wireless communication link(s), such as a network 120 or dedicated connection(s). For example, the communications unit 106 may be controlled by the processing device 102 to receive performance measurements, such as performance measurements that are from various components of the SEIS 200 of FIG. 2. The various components of the SEIS 200 of FIG. 2 may be communicably coupled to the communications unit 106 via the network 120. The performance measurements received at the communications unit 106 are input to the DT tool 114.

The I/O unit 108 allows for input and output of data. For example, the I/O unit 108 may provide a connection for user input through a keyboard, mouse, keypad, touchscreen, or other suitable input device. The I/O unit 108 may also send output to a display or other suitable output device. The I/O unit 108 can further support communications with various components of the SEIS 200 of FIG. 2. For example, input and output data of I/O unit 108 can be received from or output to one or more sensors 130, and one or more databases 132, one or more controllers 134 of a physical component or IoT and other connected data sources 136 within the SEIS 200 of FIG. 2. The sensors 130 can include roadway cameras that that provides a speed of automobiles on a roadway, a toll plaza gate that provides a count of automobiles passing through or an open/closed status of a roadway lane. The databases 132 can store relational data, such as the ON/OFF state a controller 134 related a temperature measurement from a sensor 130 that controls that controller. As described more particularly below, the SEIS 200 of FIG. 2 may include various components 130, 132, 134, 136 that are connected to the electronic device 100 at the I/O unit 108 or via the network 120.

Although FIG. 1 illustrates one example of an electronic device 100 supporting digital twin-based operational control of a physical system, various changes may be made to FIG. 1. For example, computing devices and systems come in a wide variety of configurations, and FIG. 1 does not limit this disclosure to any particular computing or communication device or system.

FIG. 2 illustrates an example Social-Ecological-Infrastructural-System (SEIS) 200 according to this disclosure. The embodiment of the SEIS 200 shown in FIG. 2 is for illustration only. Other embodiments could be used without departing from the scope of the present disclosure. The SEIS 200 of FIG. 2 may, for example, include and be used together with the electronic device 100 of FIG. 1 for supporting digital twin-based operational control of a physical system. For example, the electronic device 100 of FIG. 1 can identify critical functions and domain-centric (such as, physical, informational, ecological, or social) performance metrics of the SEIS 200 of FIG. 2, and can monitor and analyze behaviors and feedback/response mechanisms of the SEIS 200. Note, however, that the SEIS 200 of FIG. 2 may be used with any other suitable device and in any other suitable system.

The SEIS 200 includes a physical system 202 and its related metabolism components 204, stressors and risks 206, and system outputs 208. As an example only, the physical system 202 is illustrated as a real-word airport, for example, the Dallas-Fort Worth International (DFW) Airport, which is part of the United States (US) critical infrastructure. The physical system 202 includes multiple domains such as: physical domain 210, informational domain, ecological domain 212, social domain 214, infrastructural domain 216, and management system domain 218. The physical system 202 may have a porous boundary, which is illustrated by a dashed line surrounding the physical domain 210.

The ecological domain 212 may affect the social domain 214 and/or the infrastructural domain 216, as represented by the arrow 219a exiting the ecological domain 212. The arrows 219b and 219bb represent affects that the social domain 214 may impose on other domains. The arrow 219c represents affects that the infrastructural domain 216 may impose on other domains. The ecological domain 212 includes land, water, soil, wildlife, nutrients, and energy. The social domain 214 includes passengers, workforce, designers, constructors, operators, and policymakers. The infrastructural domain 216 includes airside infrastructure, terminal infrastructure, and landside infrastructure. The airside infrastructure includes an airspace and an airfield. For example, the airside infrastructure includes a parking space assigned to an arrival/departure gate for an aircraft 216a. The terminal infrastructure includes security checkpoints (e.g., access points into secured areas), airline business activities, as well as retail, food and beverage shops inside one or more terminal buildings 216b or other buildings. The landside infrastructure includes roadways, parking facilities, curbside areas, and pre-security areas. The management system domain 218 includes information and communication as subsets from the resilience matrix 300 of FIG. 3. In certain embodiments, the management system domain 218 is incorporated into the social domain 214. The social and management system domains 214 and 218 are where dynamic decision making occurs, which are typically outcome determinative based on costs. However, the DT 114, once trained, can be utilized to determine tradeoffs that may result if a proposed change is implemented upon an aspect(s) of the physical system 202.

The metabolism components 204 include resources that are consumed (or required) in the physical system 200 in order to respond to stressors/risks 206 that happen. The metabolism components 204 include an energy components 220, water components 222, information components 224, human components 226, and transport components 228. The energy components 220 include electricity, natural gas, diesel, gasoline, and propane. The energy components 220 can be classified as renewable energy 230 or non-renewable energy 232, which classes of energy are input to the physical system 202. In certain embodiments, the energy components 220 are monitored by the electronic device 100 of FIG. 1 to ascertain the amount of each type of energy input to the physical system 202. In the example shown, 67% renewable energy and 33% non-renewable energy are input to the physical system 202. An electric grid is physically coupled to the infrastructure of the physical system 202 to supply electricity to operate the various components of the infrastructural domain 216. For example, the electric grid supplies electricity to the terminal buildings for lighting and fans, to toll plazas for cameras and gates, to the central plant for chillers, valves, and pumps. The electricity grid can be owned by an electric utility company and can transmit the renewable energy 230 and the non-renewable energy 232 alike.

The water components 222 can be classified as potable 234 or reclaimed 236, which classes of energy are input to the physical system 202. In certain embodiments, the water components 222 are monitored by the electronic device 100 of FIG. 1 to ascertain the amount of each type of water input to the physical system 202. Water meters are examples of sensors 130 the measure water that is received into the physical system 202 as potable 234 or reclaimed 236.

The information components 224 include regulatory information components 238, operational information components 240, and preference information components 242. In certain embodiments, the by the electronic device 100 of FIG. 1 monitors the various types of information components 238, 240, 242 that are input to the physical system 202. For example, regulatory information components 238 can be received from an external device that connected to the network 120, such as a computer belonging to the Federal Aviation Administration (FAA) could send a ground-stop order to an electronic device 100 belonging to an airport, requiring the airport to cease operations and holds flights at their point of departure. Operational information components 240 can include an operation state (e.g., ON, OFF, failed, undergoing maintenance) of or a measurement from a physical component within the physical system 202, such as a toll plaza reader that is an ON state and that outputs a count of automobile crossings per unit of time, or a ledger of automobiles that enter/exit the physical system 202 through the toll plaza. The ledger can include a license plate number, time of enter/exit, and ID of the toll plaza lane. The preference information components 242 can be user inputs received from external devices belonging to humans 226 indicating their preferences, such as a preference for their smartphone to prioritize connecting to a fee-based secured WiFi service provided by the communications network of the airport instead of an unsecured WiFi service provided at no cost.

In certain embodiments, the human components 226 are monitored to ascertain the amount of each classification of person is entering into the physical system 202. In the example shown, 60,000 of the people entering the physical system 202 are workers 244, and 75 million of the people entering the physical system 202 are passengers 246. In certain embodiments, the electronic device 100 of FIG. 1 monitors the various classifications of people that enter the physical system 202. Particularly, an employee badge can be scanned at the workplace to indicate to the electronic device 100 where that particular worker has arrived, and a passenger ID can be scanned at an airline self-check kiosk to indicate to the electronic device 100 that a particular flight number has a passenger inside a particular area of the terminal building.

The transport components 228 include vehicles that transport passengers by road, vehicles that transport passengers by rail, and freight vehicles. The freight vehicles include light-duty, medium-duty, and heavy-duty vehicles that travel via landside. Further, the freight vehicles include light-duty, medium-duty, and heavy-duty vehicles that travel via airside. As well, the freight vehicles include aircraft. In certain embodiments, the electronic device 100 of FIG. 1 monitors the various landside vehicles 248 that enter the landside of the infrastructural domain 216, carrying passengers and/or freight. Similarly, the electronic device 100 of FIG. 1 monitors the various airside vehicles 250 that enter the airside of the infrastructural domain 216 as aircraft or as Ground Support Equipment (GSE). In certain embodiments, the airside of the infrastructural domain 216 is modeled as a first, airside DT tool 114, the landside of the infrastructural domain 216 is modeled as a second, landside DT tool 114, and the terminal of the infrastructural domain 216 is modeled as a third, building DT tool 114 that are implemented as a software platform, executed on a group of servers, and interconnectable to each other.

The inputs 230-250 from the metabolism components 204 to the physical system 202 are measured by sensors 130 or reported by IoT and other connected data sources 136 over time. To generate time-series data, the sensor measurements and the data from connected data sources 136 can be stored in databases 132 in relation to contextual information, such as day of the week, date, or time of day. Also, the data sources 136 can be updated to include time-series data such as the amounts of inputs 230-250 among the metabolism components 204 that are utilized by or consumed by the physical system 202 at a specific point in time or over a specific period of time. For example, periodically (e.g., daily, weekly, or monthly), an amount of each of the energy components 220, electricity, natural gas, diesel, gasoline, and propane, respectively, that is utilized or consumed by the physical system 202, can be added to the databases 132 as time-series data. Particularly, in certain embodiments, the amount of electricity consumption is received from a sensor 130 such as an electricity meter communicably coupled the DT 114 (e.g., via the network 120). In other embodiments, the amount of electricity consumption is obtained from a monthly invoice document that is subjected to object character recognition (OCR) technology in order to electronically recognize/extract electricity consumption values that update corresponding fields in the database 132. Similarly, a price per unit of electricity (e.g., utility rate) can be obtained from the monthly invoice document, and such utility rates from various months can be obtained for computing statistics. Similarly, the data sources 136 can be updated to include time-series data such as the amounts of stressors/risks 206 that impose risks 260-266 onto and affect operations of components the physical system 202, including affecting how much of the metabolism components 204 that the physical system 202 demands at a specific point in time or over a specific period of time. Regarding the non-renewable energy 232, fluid meters are examples of sensors 130 that measure natural gas, diesel, gasoline, and propane received into the physical system 202.

The stressors and risks 206 include technology 252, environmental degradation and climate change 254, and population growth 256. Into the physical system 202, the stressors and risks 206 provide known risks 260, “fast” risks 262, “slow” risks 264, and unknown risks 266. An example of technology 252 as a risk factor includes commercialization of 5G new radio technology that prompted governmental regulation to require a buffer (e.g., radius) to reduce potential signal interference. Another example of technology 252 includes commercialization of ride-sharing mobile applications that caused congestion of humans and idling automobiles at curbside locations. The exhaust from an increased volume of idling automobiles also contributed to degradation of air quality within the physical system 202. An example of an environmental degradation 254 is extreme temperatures. An example of a fast risk 262, which is also a technology risk 252, is a cyber-attack. Inputs to the physical system 202 from the stressors 206 are measured by sensors 130 or reported by IoT and other connected data sources 136 over time. For example, the data sources 136 include time-based temperature values forecasted and measured from a weather service, and the known risks 260 include precipitation with freezing temperatures that increases demand for energy 220 for heating, decreases landside transport 248 entering through the boundary due to iced roadway conditions impeding routes for workers 244 and passengers 246 to arrive at the airport physical system 202.

The system outputs 208 that exit the physical system 202 include benefits 268 and disbenefits 270. The benefits 268 include economic growth, jobs, tax revenue, and ecosystem services. The disbenefits 270 include air pollution, water pollution, and noise pollution.

Although FIG. 2 illustrates one example of an SEIS 200, various changes may be made to FIG. 2. For example, various components in FIG. 2 may be combined, further subdivided, replicated, omitted, or rearranged and additional components may be added according to particular needs. As a particular example, the multiple domains of the physical system 202 could include different or additional domains, such as a cognitive domain and informational domain. As another particular example, the physical system 202 of the SEIS 200 could be a city, metropolitan area, or other transportation hub (e.g., train station, bus station, helicopter transport hub).

Resilience is an important system property for complex systems, and your work provides foundation for implementing resilience in the context of airport operations. According to embodiments of this disclosure, the use of digital twins 114 (FIG. 1), AI and other advanced technologies that visualize data in complex systems and provides analytical means. The digital twin 114 enables interfacing with other digital twins and integrating resilience measurements in the context of a physical system (for example, airport operations).

Socio-ecological-infrastructural systems (SEIS), such as cities or transportation hubs, exhibit complex characteristics of unpredictability, non-linearity, interconnectivity, hierarchy, and ‘emergence’. In addition, the frequent disruptions from a combination of fast (e.g., cyber-attacks, extreme weather, terrorism) and slow (e.g., climate change, urbanization) stressors disrupt their primary objectives of moving people and freight globally and meeting performance objectives of safety, efficiency, and costs. As urbanization trends evolve, modern society increasingly relies upon complex and connected infrastructure to function in a manner supporting its sustained growth. In addition, ports (i.e., airports and seaports) depend on a high degree of coordination between interconnected and interdependent domains (e.g., physical, information, social) to achieve mutually agreed upon outcomes.

International airports prioritize safety, efficiency, and environmentally responsible operations using traditional risk assessment methods that require risk identification and quantitative evaluations of vulnerability and consequences. However, these traditional risk approaches fall short when managing novel threats (i.e., in terms of scale and complexity) and promptly mitigating direct, indirect, and cascading impacts. As a result, the ability to develop resilient airport infrastructure is imperative to meeting these multi-criteria functionality objectives and increased demands from disaster response. Embodiments of this disclosure provide resilience-driven tools to guide airports and airlines toward this new way of dealing with systemic risks.

In some embodiments, the digital twin tool 114 can be used in industry and academia because of its ability to analyze, visualize, and control complexity. However, there are three common characteristics of DTs 114 including (a) digital replica of a physical system, (b) bidirectional data exchange, and (c) connection along the entire lifecycle. In addition, with a rapidly evolving availability of time-series data through the Internet of Things (IoT) and other connected data sources, the DT 114 can now analyze and visualize asset and system-level performance to diagnose and minimize cascading failures. As a result, a compilation of DTs 114 can serve as novel decision-support toolkits to aid airports in developing resilient decision-making and operational capabilities in preparing for and absorbing, recovering from, and adapting to adverse.

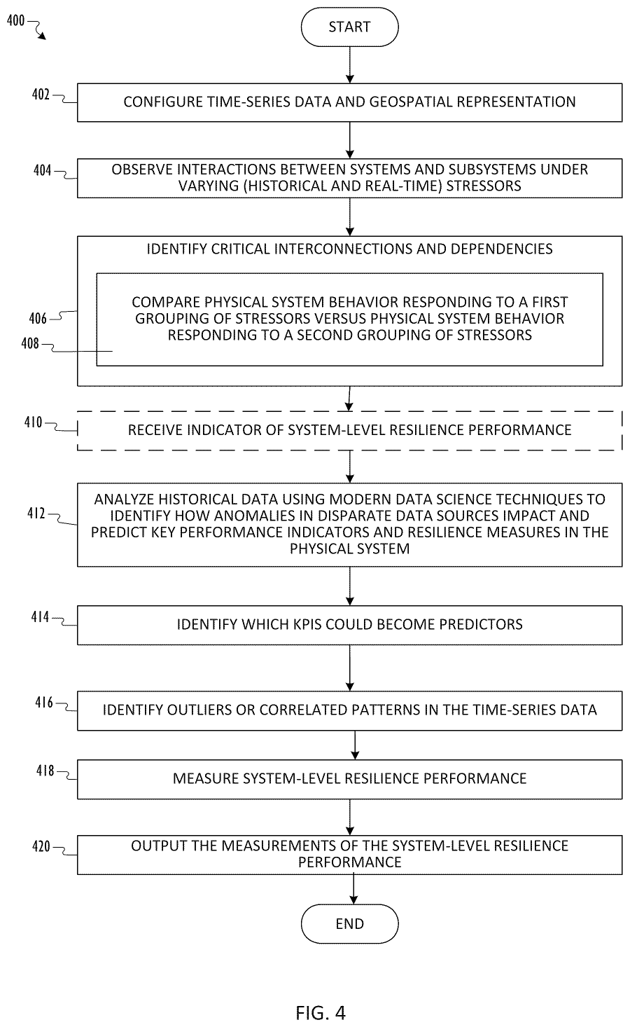

Embodiments of this disclosure integrate resilience analysis using a Resilience Matrix (e.g., RM 300 of FIG. 3) and associated methods (e.g., method 400 of FIG. 4), and DT architecture (e.g., DT 114 of FIG. 1) to visualize critical functions and system and subsystem operational characteristics under a range of threat scenarios. In addition, the integrated model could aid in providing a systems perspective (mandatory for developing resilience capabilities). As a result, the DT 114 could catalyze the aviation sector by developing the ability for threat-agnostic resilience capabilities (e.g., extreme weather events, terrorism, cyber-attacks, urbanization, technological disruptors).

FIG. 3 illustrates an example Resilience Matrix (RM) 300 according to this disclosure Particularly, the RM 300 includes mapping system domains 302 across an event management cycle of resilience functions 304. The domains 302 include physical, information, cognitive, and social. The RM cells illustrate the guidelines for developing resilience metrics, which can be combined to measure overall system resilience.

For example, using metrics derived from FIG. 3, the electronic device 100 can understand how the interacting airport systems perform across the four phases of a disruptive event for various scenarios (e.g., extreme weather, pandemics). Following a previous event management cycle of resilience functions 304, another event management cycle of resilience functions 304 begins. For example, the four phases of the disruptive event can include a planning/preparing phase 306, absorbing phase 308, recovering phase 310, and adapting phase 312. That is, each event management cycle of resilience functions 304 includes the four phases 306-312.

Although FIG. 3 illustrates one example RM 300, various changes may be made to FIG. 3. For example, various components in FIG. 3 may be combined, further subdivided, replicated, omitted, or rearranged and additional components may be added according to particular needs.

FIG. 4 illustrates an example method 400 for understanding how the interacting airport systems perform across the four phases 306-312 (shown in FIG. 3) of a disruptive event for various scenarios according to this disclosure. For ease of explanation, the method 400 is described as involving the use of the processing device 102 executing the DT 114 of the electronic device 100 of FIG. 1. However, the method 400 may involve the use of any other suitable device in any other suitable system.

As shown in FIG. 4, at block 402 of the method 400, the processing device 102 configures time-series data and a geospatial representation. That is, the electronic device 100 obtains formatting specifications for exporting the time-series data and geospatial representation into a DT software, and configures the physical system's 202 time-series data and the geospatial representation in accordance with the formatting specifications. In some embodiments, the formatting specification for exporting data is specified by the DT software that is the destination of such export.

After configuring time-series data and a geospatial 3D/2D airport ecosystem representation through the DT software, the processing device 102 enables (at block 404) observation of interactions between systems and subsystems under varying stressors and uncovers or identifies (at block 406) critical interconnections and dependencies. For example, at block 404, stressors 206 can be received as inputs, and in response, the processing device 102 generates outputs representing behaviors of the systems within the domains 210-218 within the physical system 202, and can additionally generate outputs at a more granular scale (or higher fidelity) that represent behaviors of the subsystems within a particular one of domain. To identify critical interconnections and dependencies, at block 408, the processing device 102 compares behavior of the physical system 202 responding to a first grouping of stressors 206 (e.g., extreme weather scenario of Texas 2011 ice storm) versus behavior of the physical system 202 responding to a second grouping of stressors 206 (e.g., extreme weather scenario of 2021 Winter Storm Uri). That is, at block 406, the processing device 102 compares the airport behavior during extreme weather scenarios like the Texas 2011 ice storm versus the 2021 ice storm (e.g., “cold snap”) to identify to critical interconnections and dependencies. Particularly, whether a physical system 202 (e.g., airport) is able to perform a critical function (e.g., allow takeoffs and landings) is determined based on the critical interconnections and dependencies. As an example, an airport's physical system 202 may shut down operations of the airside of the infrastructural domain 216 if workers 244, who perform tasks essential for the airport's critical function, cannot arrive at their workplaces due to landside vehicles 248 being unable to enter the physical system 202 (e.g., enter an airport toll plaza) due to external roads outside of the physical system 202 being impassable. In this example, the critical interconnections and dependencies can be identified by sensors that measure number of vehicles that pass through the toll plaza, scans of employee ID badges at the workplace, information components 224 indicating closure of an external road, and the DT 114 trained to compare with ranges of normality of toll plaza pass-through, scans of employee ID badges, and other applicable measurements.

From a discrete set of time-series data, the model within the DT 114 can be trained to learn what type of behaviors the physical system 202 has actually exhibited in response to a specified grouping of stressors (such as stressors 260-266) for a specified period of time, when a specified grouping of inputs (such as 230-250 from metabolism components 204) are received. After being trained, the DT 114 is able to predict a timeline of behavior of the physical system 202 based on a newly received grouping of inputs and received grouping of stressors.

The DT 114 includes an indicator of system-level performance. In certain embodiments, the indicator of system-level performance includes multiple indicators of system-level performance. In certain embodiments of the method 400, at block 410, a user of the DT 114 selects the indicator of system-level performance, and the DT 114 receives and utilizes the user-selected indicator. In certain embodiments of the method 400, the indicator of system-level performance is predetermined, for example, a designer of the DT 114 may choose the indicator of system-level performance that the DT 114 is then configured to utilize automatically (i.e., without user selection of the indicator). The method 400 may include a combination of these two embodiments, for example, a first indicator of system-level performance is predetermined, and a second indicator of system-level performance is user-selected. In certain scenarios, the physical system that the DT 114 models is an airport system, such that the system-level resilience performance is the airport system's resilience performance. The value of the indicator of system-level performance can be a number of takeoffs and landings per unit of time (e.g., per day of the year).

At block 412, using modern data science techniques, processing device 102 can analyze historical data from the DT software to identify or explore how anomalies in disparate data sources potentially impact and predict key performance indicators (KPIs) and resilience measures (such as measurements of the indicator of system-level performance) in the physical system 202 (e.g., an airport). An example resilience measure is the indicator of system-level performance of the DT 114.

An additional step includes, at block 414, identifying which KPIs could become predictors (or Early Warning Signals) of pending operational disturbances (i.e., critical events). For example, workers not coming to work at the airport, or passengers that purchased a ticket are not coming to the airport are examples of anomalies in a disparate data source that impacts takeoffs and landings, and each of which can be an early warning signal that a reduction of takeoffs and landings may be forthcoming. Another similar example of a KPI is load factor, which can indicate whether a disruption to takeoffs and landings is upcoming. The load factor is a percentage of utilization the number of seats and/or the amount of cargo space on an aircraft. If utilization is reduced outside of a range of normality expected, then it is likely that a disruption to takeoffs and landings is upcoming. Generally, it is more financially reasonable to fly one aircraft that has a high load factor (e.g., fully-loaded) than to fly multiple aircrafts that have a low load factor.

At block 416, by visualizing and correlating the disparate data streams, processing device 102 can identify outliers or correlated patterns in the time-series data and potentially function as predictors of future events. The processing device 102 can utilize pattern recognition algorithms on big data (such as time-series data in the database 132) to identify these outliers or correlated patterns. The time-series data's computed features and statistical summaries will be used to analyze how these metrics correlate with the critical events of interest. In addition, other modern time-series analysis, decomposition, anomaly detection, and forecasting methods can be explored to provide more in-depth insights and improve the airport's decision-making.

At block 418, the processing device 102 measures an indicator of system-level performance, such as number of takeoffs and landings over versus time. This indicator system-level performance can be compared to a range of normality, which may vary according to season, time of day, day of the week, etc. When the processing device 102 detects that measurement of the indicator system-level performance is outside of the range of normality of that indicator, the RM 300 can be used to determine which phase is applicable to the current behavior of the indicator system-level performance. Further, at block 420, the processing device 102, using the I/O unit 108 to output to an output device, outputs the measurements of the indicator of system-level resilience performance. For example, the measurements of the indicator of system-level resilience performance can be output via a user interface displayed on a display. The user interface may display the measurements of the indicator of system-level resilience performance in relation to any among the following: the first grouping of stressors, second grouping of stressors, other grouping of stressors, and grouping of inputs (such as 230-250 from metabolism components 204).

Although FIG. 4 illustrates one example of a method 400 for understanding how the interacting airport systems perform across the four phases of a disruptive event for various scenarios, various changes may be made to FIG. 4. For example, while shown as a series of steps, various steps in FIG. 4 may overlap, occur in parallel, occur in a different order, or occur any number of times.

As the sixth climate assessment report by the IPCC released in 2021 outlines, humanity is not on track to limit global warming to within 1.5° C. and calls for anthropogenic removals of CO₂ and global net zero CO₂ emissions. This call-to-action means identifying strategies for transitioning away from fossil fuels and reducing current anthropogenic emission sources while recognizing the importance of adapting critical infrastructure to the effects of climate extremes.

Historically, problems exist and there are challenges of understanding and managing and understanding extreme connected events. More specifically, the complex and contingent nature of connected extreme events causes them to possess several attributes distinct from those associated with isolated or univariate extreme events. These include a large, poorly characterized sensitivity to small changes in mean climate conditions and a low availability of data on important physical and societal characteristics. Together, these lead to a heightened risk of crossing unknown tipping points in terms of response capacity. Because connection between extreme events depends heavily on situational factors such as season, location and groups affected, essential ingredients for making progress in addressing them include careful impacts-oriented analysis, usage of higher-order metrics and collection of high-quality, high-resolution impacts data. This is an area where the power of emerging computational and communication technologies is likely to be keenly felt.

However, according to embodiments of this disclosure, DTs 114 (FIG. 1) can become the catalysts to empower decarbonization and resilience capabilities for airports because of their ability to define temporal and spatial characteristics of systemic risks and synergistic opportunities. With this newly developed integrated Resilience Matrix+DT tool (for example, DT 114), scientists can be equipped to improve their capabilities of analyzing airport disruptions across a range of interdependent critical functions and ecosystem domains. In addition, as society shifts toward renewables (e.g., renewable energy 230), DTs can help understand the cross-scale impacts and opportunities for coordinating energy loads to leverage the intermittent nature of renewables (i.e., abundant winds at night and solar during the daytime versus peak energy loads during daytime). In conjunction, supporting outcomes can drive the airport's decision-making at the ecosystem level to predict traffic and congestion better and optimize the on-airport transportation network based on aircraft movements and weather while reducing energy consumption and related emissions.

FIG. 5A illustrates a central plant optimization system 500, according to embodiments of this disclosure. The central plant optimization system 500 includes an infrastructure 501, such as terminal infrastructure of the infrastructural domain 216 of FIG. 2, and optimizes operation of the infrastructure 501. The infrastructure 501 of this embodiment is a central plant and is referred to as central plant 501 for ease of explanation. The embodiment of the central plant optimization system 500 shown in FIG. 5A is for illustration only, and other embodiments could be used without departing from the scope of this disclosure. In certain embodiments, central plant optimization system 500 of FIG. 5A includes the DT 114 of FIG. 1, such as the third, building DT 114.

The central plant optimization system 500 includes a model predictive control (MPC) 502, which includes an optimization algorithm 504, an objective 506, a set of constraints 508, models 510 of physical components of the central plant 501. The MPC 502 can be implemented by the electronic device 100 of FIG. 1. The MPC 502 in this example optimizes sequencing of chillers and thermal energy storage system in the central plant 501. In some embodiments, the optimization algorithm 504 is implemented by an external device, such as an optimization server system, that is communicably coupled to the MPC 502 to receive from the objective 506, constraints 508, and physical models 510 as inputs, to process those inputs through an MPC process that includes the optimization algorithm, and to return a cooling load value to the MPC 502.

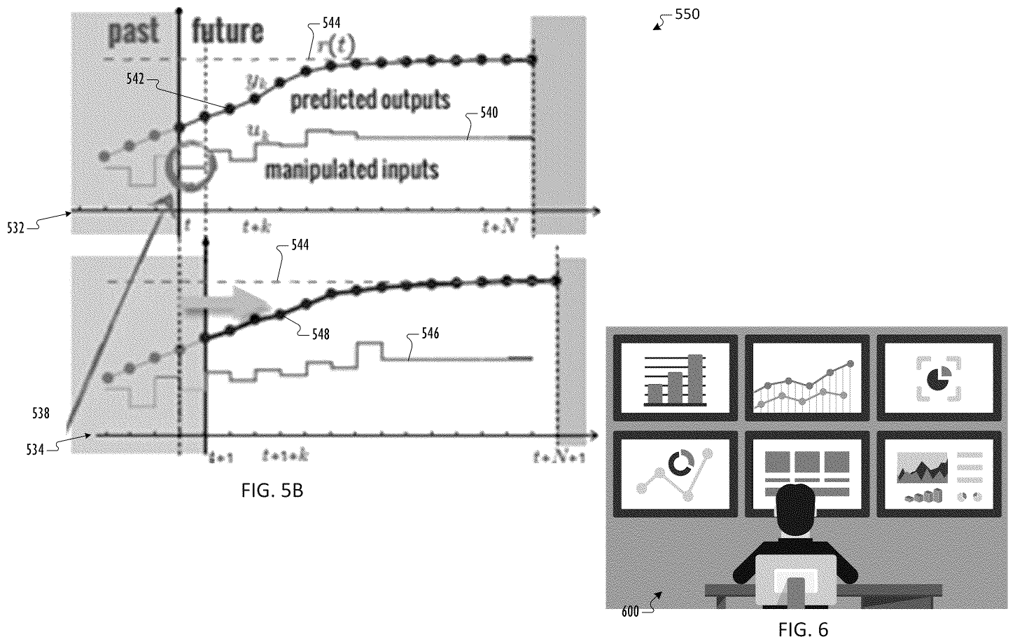

The MPC 502 sends control signals 514 to the central plant 501 for controlling operations of the central plant 501. The central plant 501 can operate in an automated-control mode, wherein an automated-control interface (AIC) 515 receives the controls signals 514 from the MPC 502 and converts to a format that the physical components of the central plant 501 are configured to function on, and provides the converted control signals to the physical components of the central plant 501 to switch the ON/OFF state of the chillers, pumps, and other physical components of the central plant 501, control setpoints, or control other functions or settings of the physical systems. Alternatively, the central plant 501 can operate in a manual mode, wherein operational control system of the central plant 501 receives the control signals 514 from the MPC 502 and causes an output device to output an instruction for a user to actuate controllers built-in the console in accordance with the control signals 514. The operational control system can be associated with a control room console (e.g., including Informative Analytics tool 600 of FIG. 6). The user of the console can be a person authorized to actuate controllers in the control room. The instruction can be output via a visual indicator, visually displayed user interface, or audio/voice user interface. For ease of explanation, FIG. 5A is described as if the central plant 501 is operating in the automated control mode. The control signals 514 can control operation of the central plant 501 by updating one or more control parameters for operating the physical components of the central plant 501. For example, control signals 514 can initially-establish, maintain, or switch, a state of the physical components of the central plant 501.

The MPC 502 generates the control signals 514 based on inputs 516 and 518 and plant information feedback 520. The stressors input 518 to the MPC 502 can the same as the input 522 to the central plant 501, representing stressors, such as weather, occupancy, flight information, and lighting loads, other loads that affect operations of the central plant 501. The optimization algorithm 504 can generate the control signals 514 based on inputs 516 and 518 and plant information feedback 520, and based on the objective 506, constraints 508, and physical models 510, for example, when the optimization algorithm 504 is implemented as an optimization server system. Particularly, the MPC 502 obtains (e.g., retrieves from storage devices 104, or receives from an external data source) a utility rate input 516 and stressors inputs 518 (e.g., representing the stressors 206 of FIG. 2). The utility rate input 516 includes a price per unit of electricity (e.g., kilowatt hour of energy and/or kilowatt of electric power) received from the utility company's electrical grid. The utility rate input 516 can be received from user input based on a contract from the utility company, or can be downloaded from a utility company's API for subscribers.

The MPC 502 automatically responds to demand response signals received from a utility's electrical grid. The utility rate input 516 can be or can include a demand response signal, in response to which, the MPC 502 may change a control signal 514 in order to change energy consumption within the central plant 501. For example, physical components of the central plant 501 that are configured with demand response-capabilities will reduce or change energy consumption based on receiving a demand response signal via the electrical grid, wherein the utility company may be contractually permitted to transmit the demand response signal during shortages of electricity generation. As another example, an operator of the utility company's electrical grid can send a message (i.e., telephone call or email) requesting demand response during a specified window of time, and such demand response signal can be received from a user input into a control room console. The user input of the demand response signal can include typing a specified window of time, activating the demand response-capabilities at a start of the specified window, or deactivating the demand response-capabilities at an end of the specified window.

In some embodiments, instead of waiting to receive a demand response signal, the MPC 502 can help maintain resilience of the electric grid by reducing load on the electric grid when a difference between the generation capacity available and the electric grid load is within a specified reserve margin. At the same time, instead of charging an energy storage (e.g., on-site battery, or thermal energy storage system (TES)) whenever the state of charge drops to a low level, the MPC 502 can enhance resilience of the electric grid by increasing load on the electric grid when the generation capacity available far exceeds the electric grid load. Particularly, the MPC 502 receives electric grid condition data (e.g., input 516) corresponding to an electric grid physically coupled to supply electricity to M chillers of the central plant 501. The electric grid condition data includes an electric grid load, and a generation capacity available to the electric grid. The electric grid load can be a measured value, for example, measured and published by a grid operator periodically (e.g., ever 5 or 10 minutes). The electric grid load can be a forecasted value, for example, predicted and published by the grid operator a day ahead or as a short-term load forecast every 5 minutes. The MPC 502 determines a charging window of time to charge an energy storage (e.g., TES) that is physically coupled to supply at least some electricity to the physical system 202, based on a determination that the electric grid load is outside of a reserve margin relative to the generation capacity available. The reserve margin can be received from the grid operator, or can be determined by the MPC 502 as value greater than the reserve margin set by the grid operator. Analogously, the MPC 502 determines an electricity conservation window of time to discharge the energy storage, based on a determination that the electric grid load is within the reserve margin relative to the generation capacity available. During the electricity conservation window of time, the MPC 502 selects a DISCHARGE state of the energy storage discharger (e.g., valve that outlets fluid from the TES) such that the energy storage releases energy to at least in part maintain the specified indoor air temperature of the building, and reduces a period during which at least some of the M chillers operate in the ON state. During the charging window of time, the MPC 502 selects a CHARGE state of the energy storage charger (e.g., valve that inlets temperature-controlled fluid into the TES) such that the energy storage does not releases energy to at least in part maintain the specified indoor air temperature of the building.

The stressors inputs 518 include real-time measurements and forecasted values of weather, occupancy, flight information, and lighting loads, other loads. The stressors inputs 518 can be received from sensors 130 or data sources 136 of FIG. 1. The stressors inputs 518 can include the various risks 260, 262, 264, and 266 from FIG. 2. Examples of the stressors inputs 518 include real-time measurements from outdoor temperature sensors and precipitation sensors located within the boundary of the airport physical system 202; indoor temperature sensors located inside one or more buildings of the airport; or forecasted weather values a function of time provided by weather service including minimum/maximum temperature, precipitation amount, probabilities of precipitation, etc.

Examples of the stressors inputs 518 include occupancy levels, for example, measurements from carbon dioxide (CO₂) detectors correlate to a level of occupancy or number of people breathing in a nearby space. Flight information is another example of the stressor input 518 that is received from an external device, which can be connected via the network 120. For example, the flight information provided from an airline can provide a number of passengers and a number of crewmembers embarking/disembarking from each aircraft, the arrival and departure times of each aircraft, etc. This flight information is an example of passenger throughput data, which indicates a timeline of a number of people entering or expected to enter a terminal building (e.g., through an arrival gate, entrance door, or inter-terminal rail), and a number of people exiting or expected to exit the terminal building (e.g., through a departure gate, exit door, or inter-terminal rail). The people entering and exiting the building not only arrive and depart via airplanes, which arrive at and depart from the building according to a flight schedule, but also, the people can be dropped off or picked up from ground transportation vehicles, which may or may not operate according to a vehicle schedule. The flight schedule is an example of a vehicle schedule, and each aircraft is an example of a vehicle that carries passengers and crewmembers.

The stressors input 518 includes other loads, such as lighting load. Light bulbs operating in a building generate and emit heat. Similarly, electrical or gas appliances that produce heat during operating inside a building increase a heat gain value associated with the building. Examples of such appliances include coffeemakers, ovens, fryers, stoves, griddles, refrigerators, hand dryers, computers, etc.

The one or more of the terminal buildings of the airport physical system 202 is climate controlled by the central plant 501. Within the central plant 501, the physical components include a thermal energy storage system (illustrated as “TES”), chillers (illustrated as CH1 through CH6), preconditioned air (PCA), tunnels (illustrated as S. tunnel and N. tunnel) and EP HVACs. The TES can be a fluid thermal storage tank having a specified storage capacity, such that fluid that is chilled at night can be used (e.g., discharged from the TES) to provide cooling to the physical system 202 during peak times of the day (e.g., times when the electric grid has high demand, or when the physical system 202 would has high demand for electricity). The TES serves to reduce electrical demand for the physical system 202. When the TES is full of fluid at the specified storage capacity, then the state of charge is 100%, but the state of charge reduces when an outlet valve opens to allow fluid to discharge (e.g., flow out) from the TES. Analogously, the state of charge of the TES increases when an inlet valve opens to allow chilled-fluid to from the chillers to flow into (e.g., charge) the TES. The physical components of the central plant 501 also includes multiple P-pumps 530, multiple S-pumps 552, and valves 554 that control fluid flow between the various physical components. The physical components of the central plant 501 are connect to each of the terminal buildings such that temperature-controlled fluid (e.g., water) is pumped by S-pumps 552 from the central plant 501 through supply pipes inside the HVAC systems of the terminal buildings in order to maintain a specified indoor air temperature of the terminal buildings. The physical components of the central plant 501 receive the fluid back from the return pipes inside the HVAC systems of the terminal building, which is returned into the TES and/or the chillers after the fluid has absorbed heat from the indoor air of the terminal buildings. The number of P-pumps can be the same as the same number of chillers. In some embodiments, the multiple P-pumps 530 are connected to each other in parallel as a first parallel grouping, the multiple chillers are connected to each other in parallel as a second parallel grouping, and the first parallel grouping is connected in series to the second parallel grouping. In some embodiments, each P-pump is connected to a respective one of the chillers. These physical components operate in response to receiving the control signals 514 and output the plant information feedback 520. In some embodiments, the multiple S-pumps 552 are connected to each other in parallel as a third parallel grouping; a fourth parallel grouping is composed from the PCA, S. tunnel, N. tunnel, and EP HVACs connected to each other in parallel; and the third parallel grouping is connected in series to the fourth parallel grouping.

The MPC 502 operates based on an objective 506, which can be to prioritize reducing costs or to prioritize reducing energy. In some embodiments, objective 506 is adjusted based on the demand response signal or utility rate input 516. The objective 506 selects to prioritize reducing consumption of electricity from the electric grid during each specified period of demand response, or whenever demand response capabilities are activated. The objective 506 can be configured to with a default setting to prioritize reducing costs of operations, such as anytime demand response is deactivated or outside of the specified period of the demand response. To prioritize reducing energy consumption, the objective 506 can adjust the optimization algorithm 504 such that discharging the TES to avoid consuming electricity has a higher priority than to consuming electricity to charge the TES.

The constraints 508 provide operating limits to the optimization algorithm 504 to ensure that the control signals 514 cause the central plant to operate within the operating limits provided as the constraints 508. The constraints 508 include an operational state of each of the physical components in the central plant, including as whether a chiller is in an ON state or an OFF state, or whether the TES in in the charging state or discharging state. The constraints 508 include a state charge of the TES, which indicates a percentage the TES storage that is filled. The constraints 508 include a specified indoor air temperature for one or more of the terminal buildings. Within the constraints 508, each building can have a respective specified indoor air temperature, or the group of buildings can share a common specified indoor air temperature. The constraints 508 include flowrates of the valves 554, and electricity consumption rates of the chillers. The constraints 508 can be modified by plant information 520 received from a physical component. For example, if a particular chiller (e.g., CH3) in a failure state, then the plant information 520 may modify the constraints 508 to prevent the MPC 502 from generating a control signal 514 that is configured to activate the particular chiller in the failure state.

The physical models 510 include a geographic information systems (GIS) model of the physical system 202, and a building information management (BIM) model of the central plant 501, and a BIM model of each of the terminal buildings in the infrastructural domain 216. For the central plant 501, the physical models 510 includes a three-dimensional (3D) model of the geometry of the central plant building, and the physical components of the central plant, including chillers, pumps, TES, etc. For each of the terminal buildings, the corresponding BIM model can include a 3D model of the geometry of the building, and a 3D model of the HVAC system inside the building. In a particular example, the physical models 510 can include 3D model of the six chillers CH1-CH6, pipes connected to outlets of the chillers and inlets of the pumps 552, control valves open or close to allow or prevent chilled fluid from flowing out of the chillers, respectively. The physical models can include sensors in the central plant, and can visually represent measurements using a color spectrum. For example, a sensor measuring chilled fluid can cause outlet pipes from the chiller to be dark blue, while a sensor measuring warmer return fluid can cause inlet pipes to the chiller to be a different color. As another example, sensor measurements can be numerically displayed on a user interface showing the digital model.

The MPC 502, utilizing the physical models 510, generates and outputs equipment curves 524 that are displayed on a user interface 526. In this example, the equipment curves 524 indicate a CCP/CDP value (on the y-axis) versus part load ratio (on the x-axis) for a corresponding physical component in the central plant 501.

The MPC 502 estimates a cooling load value as a function of time to maintain a specified indoor air temperature of a building (e.g., one or more of the terminal buildings at the airport), based on passenger throughput data corresponding to the building that is climate controlled by the central plant 501. To estimate the cooling load value, the MPC 502 computes a building occupancy based on the passenger throughput data of the input 518; estimates a first heat gain value corresponding to the building occupancy; and estimates the cooling load value based on the first heat gain value. The building occupancy increases based on people entering and decreases based on people exiting. The first heat gain value can be estimated based on an assumption that each person has a heat generate rate, for example, a heat generation rate that corresponds to a normal human body temperature (e.g., approximately 97.6° F.). The cooling load value can be estimated based on the first heat gain value and a second heat gain value. The MPC 502 estimates a second heat gain value corresponding to at least one of solar radiation through translucent surfaces of the building (e.g. glass windows, glass doors, sky lights), heat conduction through exterior surfaces of the building (e.g., exterior walls, floors in contact with the ground or outside air), or infiltration of outdoor air (e.g., opening/closing of doors, window, and ventilation).

The MPC 502 controls an ON/OFF state of at least one chiller within the central plant 501 based on the cooling load value estimated. In embodiments in which the cooling load value is received from an external device, the MPC 502 controls the ON/OFF state of the at least one chiller within the central plant 501 based on the cooling load value received. The MPC 502 controls the ON/OFF state of at least one chiller within the central plant 501 by determining, from among a total of M chillers that form the at least one chiller, N chillers to activate based on a cooling capacity of the N chillers that is greater than or equal to the cooling load value. In an example scenario, the central plant 501 includes a total of M=6 chillers, each chiller has a 5,500 ton cooling capacity, and the cooling load value is estimated to be 10,000 tons, then the MPC 502 can output controls signals 514 to N=2 chillers to switch to or maintain in the ON state, and output controls signals 514 to a remainder of the chillers (M−N=4) to switch to or maintain in the OFF state. The valves that allow fluid to flow out of the chillers can be switched to the same ON/OFF state of the respective chiller. If the constraints 508 indicate that a particular chiller (e.g., CH4) is in failure or out of service due to maintenance, then the MPC 502 can control the P-pump and valve corresponding to the failed chiller to be in the OFF state. Alternatively, the P-pump and valve corresponding to the failed chiller can automatically switch to the OFF state without control from the control signals 514, and can send the OFF state as plant information 520, thereby enabling the physical system to modify the constraints 508. In other words, components in the central plant 501 that are configured to change state based on environmental conditions can send the plant information 520 to update the MPC 502 according to the changed state.

The MPC 502, utilizing the optimization algorithm 504, generates and outputs a timeline of values representing the operations of the MPC process 528, which are displayed on a user interface 550 (also illustrated in an enlarged view as FIG. 5B). The optimization algorithm 504 enhances the functions of the MPC 502.

Now referring to FIG. 5B, the user interface 550 includes a current time t, a past before the current time, and a future after the current time. The user interface 550 is split to show first timeline 532 and a second timeline 534. Both timelines 534 and 536 include a timeslot 538 from the current time t to first time t+1, but the timeslot 538 is displayed as the future in the first timeline 532 and displayed as the past in the second timeline 534. The first timeline 532 includes manipulated inputs 540 (u k), predicted outputs 542 (y k) that converge with a function r(t) 544, which can represent a desired output level. The second timeline 534 includes inputs 546, and outputs 548 that converges with the function r(t) 544. In some embodiments, the predicted outputs 542 can represent a supply of cooling corresponding to the manipulated inputs 540 which can represent a cooling load value converted to a number of chillers in the ON state, respectively. Resiliency is improved when predicted outputs 542 for a future timeslot 538 are determined at or before the current time t, for example, when the optimization algorithm 504 includes provides manipulated inputs 540 to the ACI 515 via the control signals 514. The predicted outputs 542 ramps up and converges with the function r(t) 544 sooner and more efficiently compared to the outputs 548.

FIG. 6 illustrates an Informative Analytics tool 600 according to embodiments of this disclosure. The Informative Analytics tool 600 generates an outputs user interfaces (for example, display devices associated with facility managers) that show predicted consequences that may result if a user selects a particular alternative is selected from a set of multiple alternatives. The Informative Analytics tool 600 can receive the control signals 514 from the MPC 502 of FIG. 5A and causes an output device to output an instruction for a user to actuate controllers built-in to a control room console in accordance with the control signals 514. The control room console is associated with or is a component of the operational control system from the manufacturer of the physical components of the central plant 501. The control room console can be housed in a secured control room associated with the operational control system.

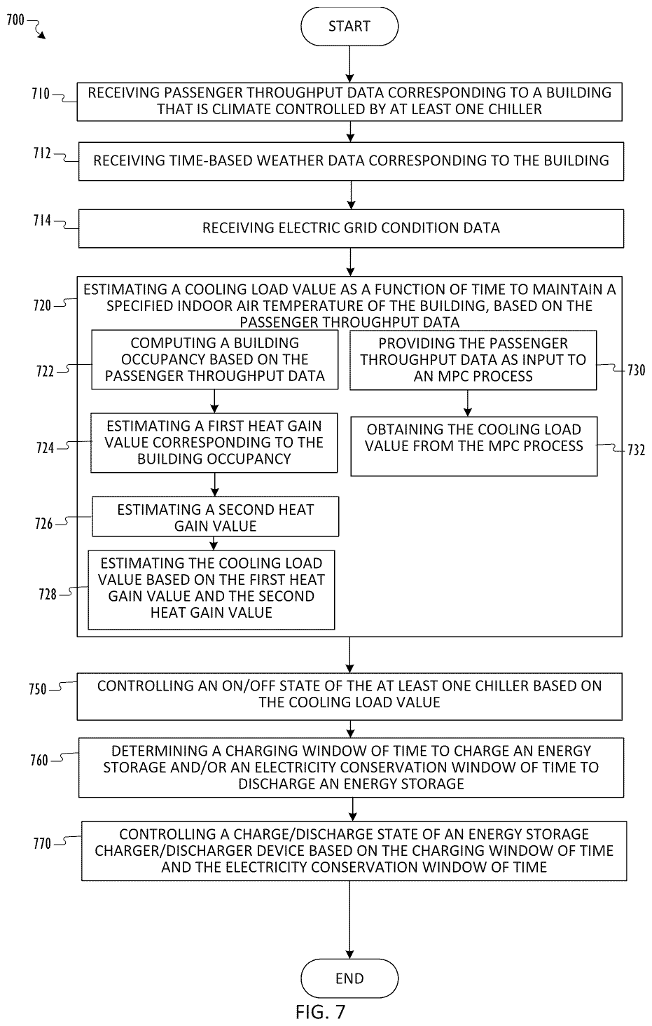

FIG. 7 illustrates a method 700 for digital twin-based operational control of a physical system, in accordance with an embodiment of this disclosure. The embodiment of the method 700 shown in FIG. 7 is for illustration only, and other embodiments could be used without departing from the scope of this disclosure. The method 700 is implemented by an electronic device or server system that includes at least one processor, such as the electronic device 100 of FIG. 1. For ease of explanation, the method 700 is described as being performed by the electronic device 100 with the processing device 102 executing the MPC 502 of FIG. 5A.

At block 710, the electronic device 100 receives passenger throughput data corresponding to a building that is climate controlled by at least one chiller. The passenger throughput data includes a vehicle schedule of vehicles arriving at and departing from the building, such as a schedule of aircraft, trains, buses, or ships arriving and departing from a terminal building at an airport, train station, bus station, or sea port. In some embodiments, the passenger throughput data includes a vehicle schedule of automobiles (including personal automobiles), for example, in a case where the personnel schedules indicate workers who will be in the terminal building, or in a case where workers use a parking space reservation software system to specify certain hours when parking spaces will be occupied for performing jobs inside the terminal building. Additionally, the passenger throughput data includes at least one of: a passenger load factor corresponding to the vehicles; or a respective passenger load factor corresponding to each vehicle among the vehicles, respectively. At block 712, the electronic device 100 receives time-based weather data corresponding to the building. At block 714, the electronic device 100 receives electric grid condition data corresponding to an electric grid physically coupled to supply electricity to M chillers that form the at least one chiller. The electric grid condition data includes an electric grid load and a generation capacity available to the electric grid.

At block 720, electronic device 100 estimates a cooling load value as a function of time to maintain a specified indoor air temperature of the building, based on the passenger throughput data. In some embodiments, to estimate the cooling load value, electronic device 100 computes (at block 722) a building occupancy based on the passenger throughput data; estimates (at block 724) a first heat gain value corresponding to the building occupancy; estimates (at block 726) a second heat gain value; and estimates (at block 728) the cooling load value based on the first heat gain value. The second heat gain value corresponds to at least one of solar radiation through translucent surfaces of the building, heat conduction through exterior surfaces of the building, or infiltration of outdoor air. Although block 728 shows that the cooling load value is estimated based on both the first and second heat gain values, it is understood that the electronic device 100 can estimate one of the heat gain values (for example, the first heat gain value), and estimate the cooling load base on the one heat gain value.

As shown at block 730, in some embodiments, electronic device 100 estimates the cooling load value by providing the passenger throughput data as input to a model predictive control (MPC) process that computes the building occupancy based on the passenger throughput data, estimates the first heat gain value corresponding to the building occupancy, and estimates the cooling load value based on the first heat gain value. As an example, to provide the passenger throughput data as the input to the MPC process, the electronic device 100 transmits, via a network connection, the passenger throughput data to an external server system that is configured to processes the input through the MPC process. As shown at block 732, in such embodiments, electronic device 100 estimates the cooling load value by obtaining the cooling load value from the MPC process. As an example, to obtain the cooling load value from the MPC process, the electronic device receives, from the external server system, the cooling load value.

At block 750, electronic device 100 controls an ON/OFF state of the at least one chiller based on the cooling load value. The electronic device 100 controls the ON/OFF state of the at least one chiller by determining, from among M chillers that form the at least one chiller, N chillers to activate based on a cooling capacity of the N chillers that is greater than or equal to the cooling load value. In embodiments that include an automated-control mode, the electronic device 100 controls the ON/OFF state of the at least one chiller by automatically controlling an operational control system to output control signals to the N chillers to switch to or maintain in the ON state and to a remainder of the at least one chiller to switch or maintain in the OFF state. In embodiments that include a manual mode, the electronic device 100 controls the ON/OFF state of the at least one chiller by outputting, via an output device associated with the operational control system, an instruction for a user to switch the N chillers to the ON state and to switch the remainder of the at least one chiller to the OFF state, or to optionally control other settings.

At block 760, electronic device 100 determines a charging window of time to charge an energy storage, based on a determination that the electric grid load is outside of a margin relative to the generation capacity available. Also at block 760, electronic device 100 determines an electricity conservation window of time to discharge an energy storage, based on a determination that the electric grid load is within a margin relative to the generation capacity available.

At block 770, the electronic device 100 controls a CHARGE/DISCHARGE state of an energy storage charger/discharger device based on the charging window of time and the electricity conservation window of time. Particularly, during the electricity conservation window of time, the electronic device 100 selects a DISCHARGE state of the energy storage discharger such that the energy storage releases energy to at least in part maintain the specified indoor air temperature of the building, and reduces a period during which at least some of the M chillers operate in the ON state. Additionally, during the charging window of time, the electronic device 100 selects a CHARGE state of the energy storage discharger such that the energy storage does not releases energy to at least in part maintain the specified indoor air temperature of the building.

Although FIG. 7 illustrates an example method 700 for digital twin-based operational control of a physical system, various changes may be made to FIG. 7. For example, while shown as a series of steps, various steps in FIG. 7 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in this patent document should not be read as implying that any particular element, step, or function is an essential or critical element that must be included in the claim scope. Also, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method implemented by at least one processor, the method comprising:
receiving passenger throughput data corresponding to a building that is climate controlled by at least one chiller;
estimating a cooling load value as a function of time to maintain a specified indoor air temperature of the building, based on the passenger throughput data; and
controlling an ON/OFF state of the at least one chiller based on the cooling load value.

2. The method of claim 1, wherein:
the passenger throughput data includes a vehicle schedule of vehicles arriving at and departing from the building, and at least one of:
a passenger load factor corresponding to the vehicles, or
a respective passenger load factor corresponding to each vehicle among the vehicles, respectively; and
estimating the cooling load value further comprises:
computing a building occupancy based on the passenger throughput data;
estimating a first heat gain value corresponding to the building occupancy; and
estimating the cooling load value based on the first heat gain value.

3. The method of claim 2, wherein estimating the cooling load value further comprises:
providing the passenger throughput data as input to a model predictive control (MPC) process that
computes the building occupancy based on the passenger throughput data,
estimates the first heat gain value corresponding to the building occupancy, and
estimates the cooling load value based on the first heat gain value; and
obtaining the cooling load value from the MPC process.

4. The method of claim 3, wherein:
providing the passenger throughput data as the input to the MPC process further comprises:
transmitting, via a network connection, the passenger throughput data to an external server system that is configured to processes the input through the MPC process; and
obtaining the cooling load value from the MPC process further comprises:
receiving, from the external server system, the cooling load value.

5. The method of claim 2, further comprising:
receiving time-based weather data corresponding to the building;
estimating the cooling load value further by:
estimating a second heat gain value corresponding to at least one of solar radiation through translucent surfaces of the building, heat conduction through exterior surfaces of the building, or infiltration of outdoor air; and
estimating the cooling load value based on the first heat gain value and the second heat gain value.

6. The method of claim 1, wherein controlling the ON/OFF state of the at least one chiller further comprises:
determining, from among M chillers that form the at least one chiller, N chillers to activate based on a cooling capacity of the N chillers that is greater than or equal to the cooling load value; and
at least one of:
automatically controlling an operational control system to output control signals to the N chillers to switch to or maintain in the ON state and to a remainder of the at least one chiller to switch or maintain in the OFF state; or
outputting, via an output device associated with the operational control system, an instruction for a user to switch the N chillers to the ON state and to switch the remainder of the at least one chiller to the OFF state.

7. The method of claim 1, further comprising:
receiving electric grid condition data corresponding to an electric grid physically coupled to supply electricity to M chillers that form the at least one chiller, the electric grid condition data including an electric grid load and a generation capacity available to the electric grid;
determining a charging window of time to charge an energy storage, based on a determination that the electric grid load is outside of a margin relative to the generation capacity available;
determining an electricity conservation window of time to discharge an energy storage, based on a determination that the electric grid load is within a margin relative to the generation capacity available;
during the electricity conservation window of time, selecting a DISCHARGE state of an energy storage discharger such that the energy storage releases energy to at least in part maintain the specified indoor air temperature of the building, and reducing a period during which at least some of the M chillers operate in the ON state; and
during the charging window of time, selecting a CHARGE state of the energy storage discharger such that the energy storage does not releases energy to at least in part maintain the specified indoor air temperature of the building.

8. An electronic device comprising:
at least one processor configured to:
receive passenger throughput data corresponding to a building that is climate controlled by at least one chiller;
estimate a cooling load value as a function of time to maintain a specified indoor air temperature of the building, based on the passenger throughput data; and
control an ON/OFF state of the at least one chiller based on the cooling load value.

9. The electronic device of claim 8, wherein:
the passenger throughput data includes a vehicle schedule of vehicles arriving at and departing from the building, and at least one of:
a passenger load factor corresponding to the vehicles, or
a respective passenger load factor corresponding to each vehicle among the vehicles, respectively; and
to estimate the cooling load value, the at least one processor is further configured to:
compute a building occupancy based on the passenger throughput data;
estimate a first heat gain value corresponding to the building occupancy; and
estimate the cooling load value based on the first heat gain value.

10. The electronic device of claim 9, wherein to estimate the cooling load value, the at least one processor is further configured to:
provide the passenger throughput data as input to a model predictive control (MPC) process that
computes the building occupancy based on the passenger throughput data,
estimates the first heat gain value corresponding to the building occupancy, and
estimates the cooling load value based on the first heat gain value; and
obtain the cooling load value from the MPC process.

11. The electronic device of claim 10, wherein:
to provide the passenger throughput data as the input to the MPC process, the at least one processor is further configured to:
transmit, via a network connection, the passenger throughput data to an external server system that is configured to processes the input through the MPC process; and
to obtain the cooling load value from the MPC process, the at least one processor is further configured to:
receive, from the external server system, the cooling load value.

12. The electronic device of claim 9, wherein the at least one processor is further configured to:
receive time-based weather data corresponding to the building;
estimate the cooling load value further by:
estimating a second heat gain value corresponding to at least one of solar radiation through translucent surfaces of the building, heat conduction through exterior surfaces of the building, or infiltration of outdoor air; and
estimating the cooling load value based on the first heat gain value and the second heat gain value.

13. The electronic device of claim 8, wherein to control the ON/OFF state of the at least one chiller, the at least one processor is further configured to:
determine, from among M chillers that form the at least one chiller, N chillers to activate based on a cooling capacity of the N chillers that is greater than or equal to the cooling load value; and
at least one of:
automatically control an operational control system to output control signals to the N chillers to switch to or maintain in the ON state and to a remainder of the at least one chiller to switch or maintain in the OFF state; or
output, via an output device associated with the operational control system, an instruction for a user to switch the N chillers to the ON state and to switch the remainder of the at least one chiller to the OFF state.

14. The electronic device of claim 8, wherein the at least one processor is further configured to:
receive electric grid condition data corresponding to an electric grid physically coupled to supply electricity to M chillers that form the at least one chiller, the electric grid condition data including an electric grid load and a generation capacity available to the electric grid;
determine a charging window of time to charge an energy storage, based on a determination that the electric grid load is outside of a margin relative to the generation capacity available;
determine an electricity conservation window of time to discharge an energy storage, based on a determination that the electric grid load is within a margin relative to the generation capacity available;
during the electricity conservation window of time, select a DISCHARGE state of an energy storage discharger such that the energy storage releases energy to at least in part maintain the specified indoor air temperature of the building, and reducing a period during which at least some of the M chillers operate in the ON state; and
during the charging window of time, select a CHARGE state of the energy storage discharger such that the energy storage does not releases energy to at least in part maintain the specified indoor air temperature of the building.

15. A non-transitory computer readable medium embodying a computer program, the computer program comprising computer readable program code that, when executed by a processor of an electronic device, causes the electronic device to:
receive passenger throughput data corresponding to a building that is climate controlled by at least one chiller;
estimate a cooling load value as a function of time to maintain a specified indoor air temperature of the building, based on the passenger throughput data; and
control an ON/OFF state of the at least one chiller based on the cooling load value.

16. The non-transitory, computer readable medium of claim 15, wherein:
the passenger throughput data includes a vehicle schedule of vehicles arriving at and departing from the building, and at least one of:
a passenger load factor corresponding to the vehicles, or
a respective passenger load factor corresponding to each vehicle among the vehicles, respectively; and
the program code that, when executed, causes the electronic device to estimate the cooling load value further comprises program code that, when executed, causes the electronic device to:
compute a building occupancy based on the passenger throughput data;
estimate a first heat gain value corresponding to the building occupancy; and
estimate the cooling load value based on the first heat gain value.

17. The non-transitory, computer readable medium of claim 16, wherein the program code that, when executed, causes the electronic device to estimate the cooling load value further comprises program code that, when executed, causes the electronic device to:
provide the passenger throughput data as input to a model predictive control (MPC) process that
computes the building occupancy based on the passenger throughput data,
estimates the first heat gain value corresponding to the building occupancy, and
estimates the cooling load value based on the first heat gain value; and
obtain the cooling load value from the MPC process.

18. The non-transitory, computer readable medium of claim 17, wherein:
the program code that, when executed, causes the electronic device to provide the passenger throughput data as the input to the MPC process further comprises program code that, when executed, causes the electronic device to:
transmit, via a network connection, the passenger throughput data to an external server system that is configured to processes the input through the MPC process; and
the program code that, when executed, causes the electronic device to obtain the cooling load value from the MPC process further comprises program code that, when executed, causes the electronic device to:
receive, from the external server system, the cooling load value.

19. The non-transitory, computer readable medium of claim 16, wherein the program code that, when executed, causes the electronic device to:
receive time-based weather data corresponding to the building; and
estimate the cooling load value further by:
estimating a second heat gain value corresponding to at least one of solar radiation through translucent surfaces of the building, heat conduction through exterior surfaces of the building, or infiltration of outdoor air; and
estimating the cooling load value based on the first heat gain value and the second heat gain value.

20. The non-transitory, computer readable medium of claim 15, wherein the program code that, when executed, causes the electronic device to control the ON/OFF state of the at least one chiller further comprises program code that, when executed, causes the electronic device to:
determine, from among M chillers that form the at least one chiller, N chillers to activate based on a cooling capacity of the N chillers that is greater than or equal to the cooling load value; and
at least one of:
automatically control an operational control system to output control signals to the N chillers to switch to or maintain in the ON state and to a remainder of the at least one chiller to switch or maintain in the OFF state; or
output, via an output device associated with the operational control system, an instruction for a user to switch the N chillers to the ON state and to switch the remainder of the at least one chiller to the OFF state.
